(19) United States
(12) Patent Application Publication
(10) Pub. No.: US 2008/0121632 A1
(43) Pub. Date: May 29, 2008

(54) SMOKING AND BAKING OVEN

(76) Inventor: Ching-Hsiang Wang, Taipei (TW)

Correspondence Address: CHING-HSIANG WANG, 235 Chung-Ho, Box 8-24, Taipei, omitted

(21) Appl. No.: 11/831,978

(22) Filed: Aug. 1, 2007

Related U.S. Application Data
(63) Continuation-in-part of application No. 11/604,381, filed on Nov. 27, 2006, now abandoned.
Application No. 11/604,381 is a continuation-in-part of application No. 11/724,778, filed on Mar. 12, 2007.

(51) Int. Cl. A21B 1/00; A21B 1/02; F24C 15/00; F27D 7/00

(52) U.S. Cl. 219/393; 126/21 R; 219/396; 219/400

(57) ABSTRACT

A smoking and baking oven has an oven body, a smoking box and a casing; the oven body having a receiving chamber and at least two different heating elements; a first heating element and a second heating element; the second heating element being installed at an outer side or inner side of the receiving chamber; and the second heating element being installed in the receiving chamber; the smoking box being installed on the second heating element; the second heating element will heat woods in the smoking box and thus generate smoke for smoking foods; the casing enclosing the oven body; temperature tolerable cotton being installed between the casing and the oven body. Electric heating is used to bake food and smoking is used to smoke food so that the oven has both the effect of smoking and baking.

The present invention is a continuation in part (CIP) of U.S. patent application with Ser. Nos. 11/604,381 and 11/724,778 which are invented and assigned to the inventor and applicant of the present invention, and thus the contents of U.S. patent application Ser. Nos. 11/604,381 and 11/724,778 are incorporated into the present invention as a part of the present invention.

### FIELD OF THE INVENTION

The present invention relates to ovens, and particularly to a smoking and baking oven, wherein electric heating is used to bake food and smoking is also used to smoke food so that the oven has both the effects of smoking and baking.

### BACKGROUND OF THE INVENTION

A prior art oven A1 is illustrated in FIG. 1. A bottom or interior of the oven is installed with electric heating device A11 (maybe a fan is also added). The baked object is placed in a baking disk A10. A door A12 is closed. Electric generated heat is transferred into the oven for baking foods. However in the prior art oven Al, heat is radiated to the baked object directly so that the baking effect is not preferred. For example heating is not uniform due to the distances of the different parts of the baked object to the heat source. As a result, it is possible that one side of the baked object is cooked and another side has not been cooked or the exterior of the baked object is cooked, while the interior thereof has not been cooked. Thus, in baking process, the door of the oven is often to be opened for turning the baked object.

Moreover, in the prior art oven the door of oven is often opened and closed again and again. The door in the prior art design is not preferred and thus as for a long time, gaps are generated between the door and the front side of the oven. Thus the heat in the oven will dissipate out.

### SUMMARY OF THE INVENTION

Accordingly, the primary object of the present invention is to provide a smoking and baking oven, wherein electric heating is used to bake food and smoking is also used to smoke food so that the oven has both the effects of smoking and baking.

Another object of the present invention is to provide a smoking and baking oven, wherein the door of the oven can be tightly engaged with the oven body so that the vapor and smoke will not drain out from the receiving chamber.

A further object of the present invention is to provide a smoking and baking oven, wherein the receiving chamber of the oven body is installed with a supporting frame which can be taken out for cleaning.

A yet object of the present invention is to provide a smoking and baking oven, wherein a lower side of the oven body is installed with a water box, condensed water on the door of the oven body can flow downwards to the water box without pollute the table or the receiving chamber of the oven body. The water box can be drawn out for cleaning.

To achieve above object, the present invention provides a smoking and baking oven having an oven body, a smoking box and a casing; the oven body having a receiving chamber and at least two different heating elements; a first heating element and a second heating element; the second heating element being installed at an outer side or inner side of the receiving chamber; and the second heating element being installed in the receiving chamber; the smoking box being installed on the second heating element; the second heating element will heat woods in the smoking box and thus generate smoke for smoking foods; the casing enclosing the oven body; temperature tolerable cotton being installed between the casing and the oven body. Electric heating is used to bake food and smoking is also used to smoke food so that the oven has both the effect of smoking and baking.

The various objects and advantages of the present invention will be more readily understood from the following detailed description when read in conjunction with the appended drawing.

### BRIEF DESCRIPTION OF THE DRAWINGS

FIG. 1 is a structural view of the prior art oven.

FIG. 2 is an exploded perspective view of the smoking and baking oven of the present invention.

FIG. 3 is an assembled cross sectional view of the present invention.

FIG. 3A is a schematic view showing the drain proof strip and the door buckle of the present invention.

FIG. 4 is an exploded perspective view of the smoking box of the present invention.

FIG. 5 is an assembled perspective view of the smoking box of the present invention.

FIG. 6 shows the use of the present invention.

FIG. 7 is an exploded perspective view showing another embodiment of the present invention.

FIG. 8 is an assembled cross sectional view of another embodiment of the present invention.

FIG. 9 shows the use of another embodiment of the present invention.

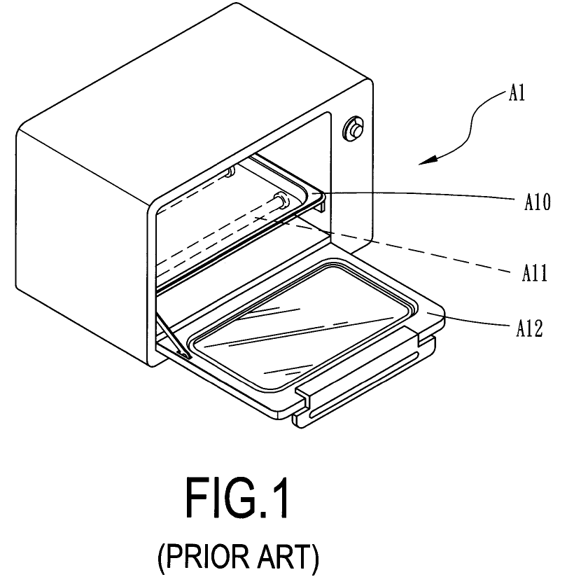

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

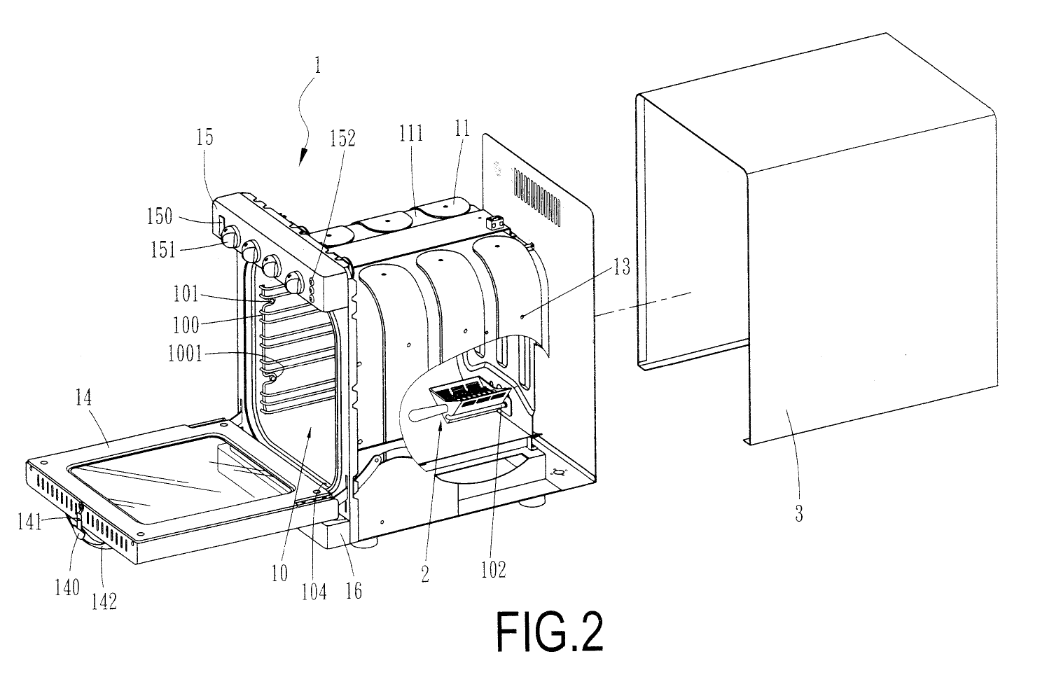

Referring to FIGS. 2 to 6, the present invention is formed by an oven body 1, a supporting frame 100 and an outer casing 3. The oven body 1 has a receiving chamber 10, a first heating element 11 and a second heating element 12. The first heating element 11 heats the receiving chamber 10 for baking a food therein. The second heating element 12 is inserted into the supporting frame 100. The oven body 1 further includes a retainer 13, a door 14, a control panel 15, and a water box 16. Food is placed into the receiving chamber 10 of the oven body 1 and then the door is closed so as to form with a sealed space. By electric heating the food in the receiving chamber 10 will be baked. Two lateral inner walls of the receiving chamber 10 are installed with supporting frames 100 which are fixed to the walls by buckles 101 (such as screws). Each supporting frame 100 is formed with buckling grooves 1001 for buckling the buckles 101.

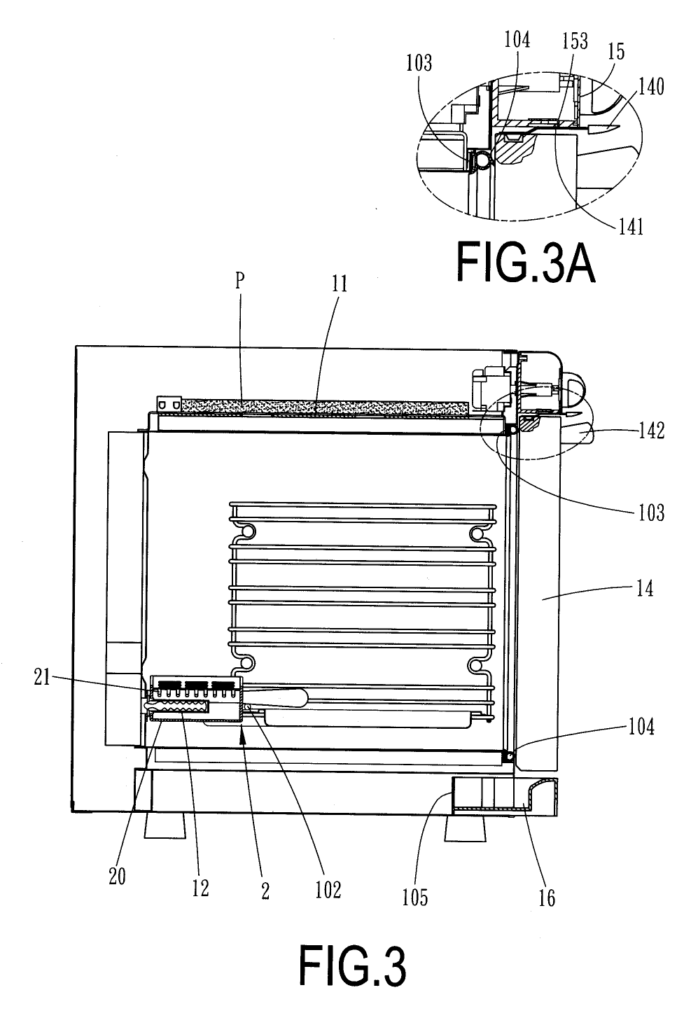

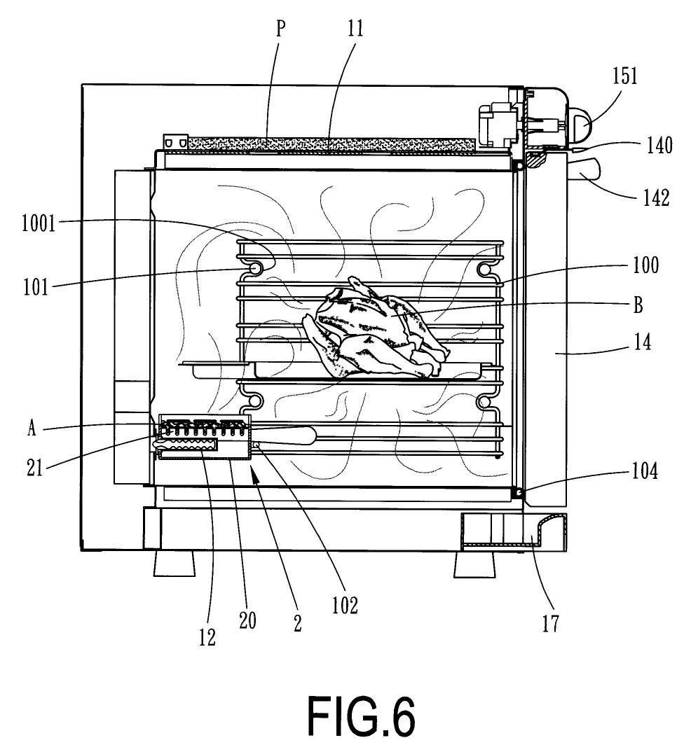

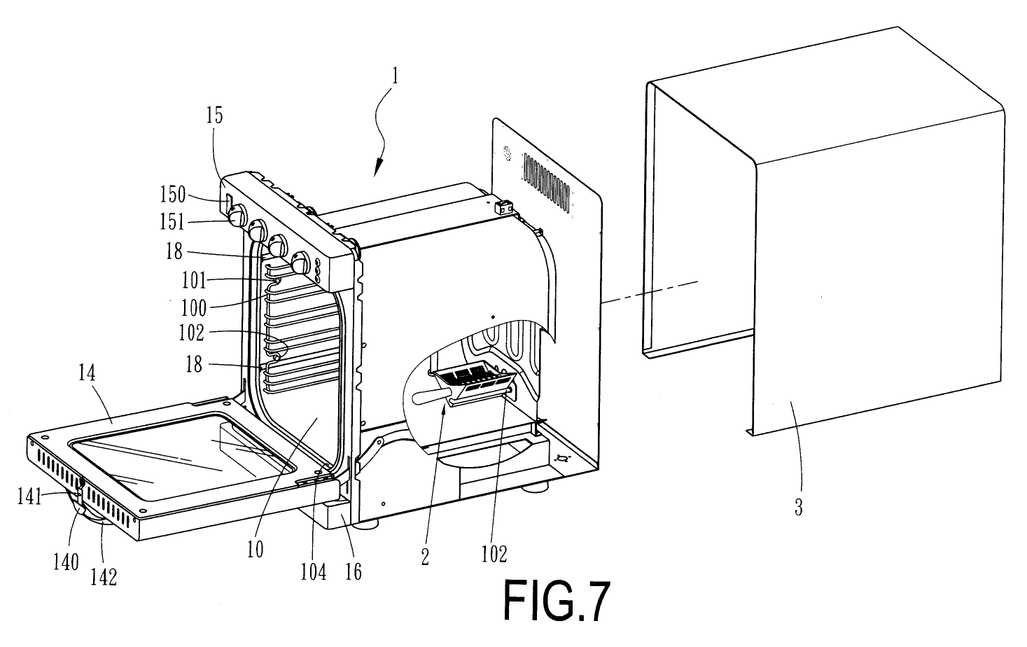

The supporting frames 100 serves to install the baking net or baking frame for receiving foods. A rear lower side of the receiving chamber 10 is installed with a supporter 102. A front end of the receiving chamber 10 of the oven body 1 is formed with embedding groove 103 for fixing a drain proof strip (see FIGS. 3 and 3A). Preferably, the drain proof strip 104 is made of silicon gel which is heat tolerant and is stable (referring to FIGS. 6 and 7). The drain proof strip 104 serves to tightly seal the space between the door 14 and oven body 1. Besides, a bottom of the oven body 1 has a recess 105. An outer side of the oven body 1 has the first heating element 11. The first heating element 11 is one of the heating sheets, heating tubes, and heating ropes. The first heating element 11 is fixed to outer surfaces of the oven body 1 by positioning unit 13. A layer of insulating paper 111 serves to space the first heating element 11 from the oven body 1. The insulating paper 111 is for example mica paper so as to have preferred insulation therebetween. An outer surface of the oven body 1 is installed with the first heating element 11. Then temperature tolerable cotton P encloses the first heating element 11 so as to avoid the heat emitted from the first heating element 11 disperses out. The second heating element 12 is installed in the receiving chamber 10 of the oven body 1. The second heating element 12 is installed to the supporter 102. The door 14 has a steel elastic door buckling unit 140 at an upper side of the door. A stop portion 141 is protruded from the buckling unit 140. A handle 142 is installed on the door. The door 14 is further installed with a handle 142. A control panel 15 is installed at a front upper side of the oven body 1 and is above the door 14. A control panel 15 is installed with a switch 150, a rotary button 151, and an indicating lights 152. A lower side of the control panel 15 is installed with a buckling recess 153 corresponding to a door buckle 140 of the door 14 (referring to FIG. 3A). The door buckle 140 is protruded with a stopper 141 which can be buckled to the buckling recess 153 of the control panel 15 by pressing the door buckle 140 downwards. As a result, the door 14 is tightly engaged to the oven body 1. If the door buckle 140 in the engaging state is further pressed downwards, the door 14 will release from the oven body 1.

A drawer like water box 16 is installed below the door 14 for receiving condensing water flowing out from the door 14. The water box 16 can be taken out freely for cleaning.

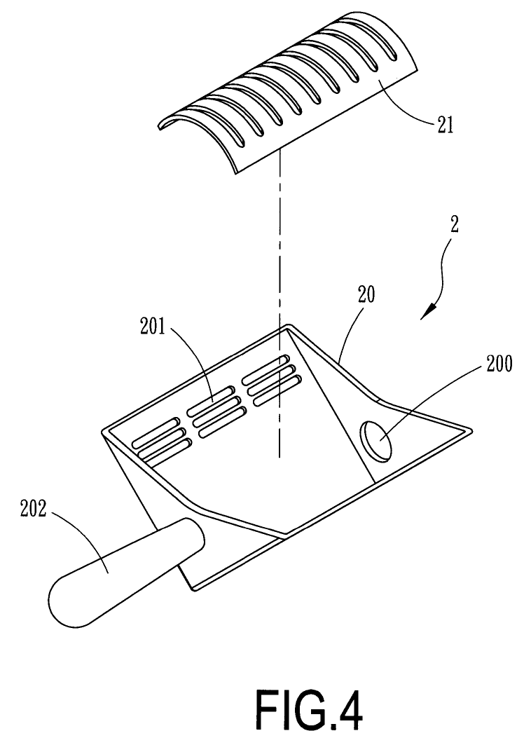

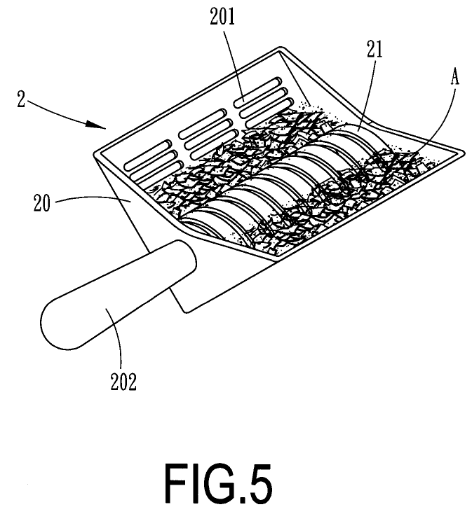

A smoking box 2, referring to FIGS. 4 and 5, is installed on the second heating element 12 of the oven body 1. The second heating element 12 is inserted into the smoking box 2. The smoking box 2 is installed on the supporter 102. The smoking box 2 includes a box body 20 which has an upper side and a lower side. A rear side of the box body 20 is formed with a plurality of vent holes 201. A front side of the box body 20 is extended with a handle 202. A smoke box net 21 is installed above the second heating element 12 and is in the box body 20. The smoke box net 21 serves to receive a plurality of wood sheets A (such as wood sheets of bay trees). A cover serves to cover the box body 20.

A casing 3 has a U shape covering an outer side of the oven body 1.

Referring to FIGS. 2 to 6, the operation of the present invention is illustrated. Firstly, the smoke box net 21 is placed in the box body 20. Then the wood sheets A are placed on the smoke box net 21. Then the user holds the handle 202 so as to place the smoking box 2 on the supporter 102 at the rear lower side of the receiving chamber 10. The second heating element 12 passes through the through hole 200 of the box body 20 and is placed below the smoke box net 21. Then disk (baking frame) with food B is placed upon the supporting frame 100. Then the door 14 is closed and the stopper 141 of the door buckle 140 will be buckled to the buckling recess 153 of the control panel 15. The user can adjust the temperature and time setting from the control panel 15 for smoking and baking.

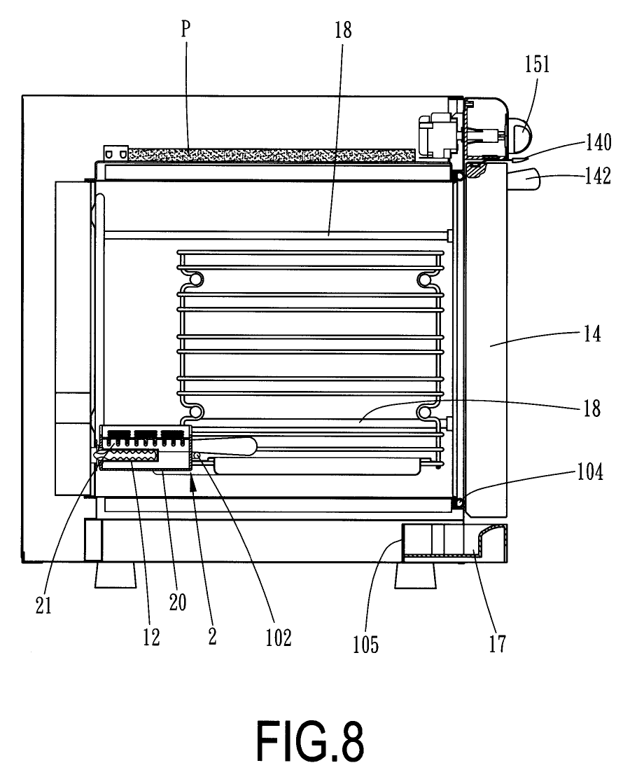

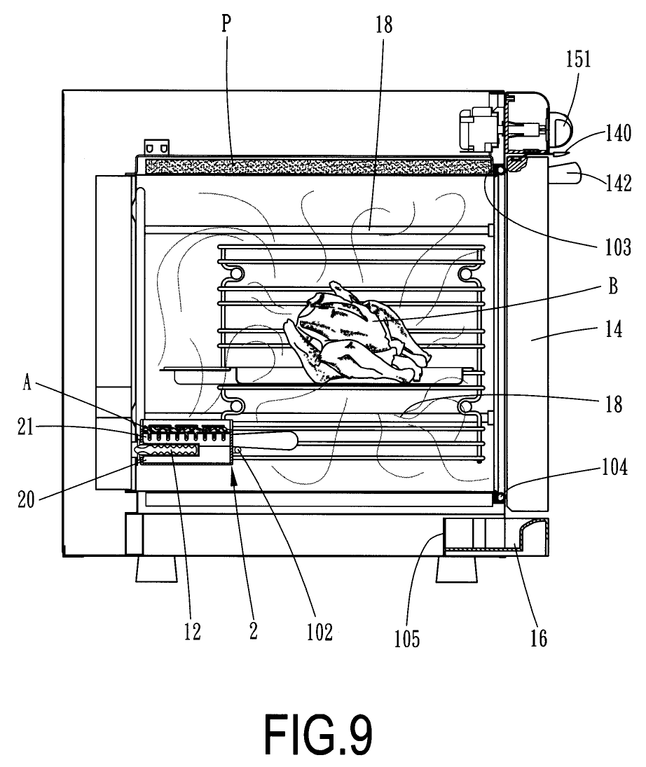

Another embodiment of the present invention is illustrated with reference to FIGS. 7 to 9, in this embodiment, those identical to the above embodiment will not be further described herein. Only those different from above embodiment are described. In this the present invention, the first heating element 18 is installed in the receiving chamber 10 of the oven body 1 and the first heating element 18 is an electric heating tube.

Therefore, by the two independent heating elements for smoking and baking, the first heating element 11 (18) serves to bake the food B in the receiving chamber 10 and the second heating element 12 will smoke the woods A in the smoking box 2. Then the smoke from the wood A will be full of the receiving chamber 10 so that the food B is baked and smoked. As a result, the food will has the effects of smoking color and odor of woods.

After baking, the door 14 is opened and the food B is taken out. The door buckle 140 on the upper side of the door 14 is pressed so that the stopper 141 is separated from the buckling recess 153 of the control panel 15. Then by holding the handle 142 of the door 14, the door 14 can be opened fully so as to take the food B out of the receiving chamber 10.

Furthermore, in smoking process, vapor will accumulate on the inner wall of the door 14. When the door 14 is opened, the vapor will condense due to the temperature difference between the interior of the oven body 1 and the exterior of the oven body 1 so as to become water drops. Then the water drops will fall down to the water box 16 without polluting the table surface.

Advantages and features of the present invention will be described herein.

1. In the present invention, electric heating is used to bake food and smoking is also used to smoke food so that the oven has both the effect of smoking and baking.

2. The present invention has two different heating elements for smoking and baking. The woods A in the box body 20 will be heated so that the odor of the woods will permeate into the food.

3. The supporting frame 100 can be taken down easily and conveniently for cleaning the oven body 1, receiving chamber 10 and the supporting frame 100.

4. The silicon gel drain proof strip 104 at a front end of the receiving chamber 10 of the oven body 1 will tightly seal the space between the door 14 and the receiving chamber 10 so that the hot vapor, heat energy and smoke will not release out.

5. In the present invention, the door buckle 140 has a stopper 141 which can be engaged to the buckling recess 153 of the control panel 15 so that the door 14 is tightly engaged to the oven body 1. When the baking operation is complete, it is only necessary to press the door buckle 140 downwards, the stopper 141 will separate from the buckling recess 153. Thus the door 14 is released from the oven body 1 and the door 14 can be opened for taking the food B.

6. The water box 16 at the front lower side of the oven body 1 can receive the condensed water flowing down from the inner wall of the door 14. No condensed water will flow to the table surface or the interior of the oven body 1. Furthermore, the water box 16 can be taken out for cleaning.

7. The smoking box 2 is installed at a rear wall of the receiving chamber 10 of the oven body 1 and is installed on the supporter 102. One side of the smoking box 2 has a handle 202 so that the smoking box 2 can be taken out easily.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A smoking and baking oven having an oven body, a smoking box and a casing; the oven body having a receiving chamber and at least two different heating elements; a first heating element and a second heating element; the second heating element being installed at an outer side of the receiving chamber; and the second heating element being installed in the receiving chamber; the smoking box being installed on the second heating element; the second heating element will heat woods in the smoking box and thus generate smoke for smoking foods; the casing enclosing the oven body; and temperature tolerable cotton being placed between the casing and the oven body.

2. The smoking and baking oven as claimed in claim 1, wherein an inner wall of the receiving chamber are installed with at least two bucking units; and the receiving chamber is installed with a supporting frame which is buckled to the buckling units by using the buckling recesses of the supporting frame to buckle the buckling units.

3. The smoking and baking oven as claimed in claim 1, wherein a lower side of the receiving chamber has a supporter and a front end of the receiving chamber of the oven body is formed with embedding groove for fixing a drain proof strip.

4. The smoking and baking oven as claimed in claim 1, wherein the first heating element is fixed to an outer surface of the oven body by positioning unit, and a layer of insulating paper serves to isolate the first heating element and the oven body.

5. The smoking and baking oven as claimed in claim 1, wherein a front side of the oven body is installed with a door and a control panel and the door has a door buckle and a handle; and the door buckle is protruded with a stopper which is made of elastic steel sheet.

6. The smoking and baking oven as claimed in claim 1, wherein a bottom of the oven body is formed with a recess for receiving a drawing like water box; the water box can be drawn out so as to be located at a lower side of the door.

7. The smoking and baking oven as claimed in claim 1, wherein the smoking box includes a box body which has an upper side and a lower side; a rear side of the box body is installed with a plurality of vent holes; a front side of the box body is extended with a handle; a smoke box net is installed above the second heating element and is in the box body; the smoke box net serves to receive a plurality of wood sheets.

8. A smoking and baking oven having an oven body, a smoking box and a casing; the oven body having a receiving chamber and at least two different heating elements; a first heating element and a second heating element which are installed in the receiving chamber; the smoking box being installed on the second heating element; the second heating element will heat woods in the smoking box and thus generate smoke for smoking foods; the casing enclosing the oven body; and temperature tolerable cotton being installed between the casing and the oven body.
